(19) United States
(12) Patent Application Publication
(10) Pub. No.: US 2006/0238545 A1
(43) Pub. Date: Oct. 26, 2006

(54) HIGH-RESOLUTION AUTOSTEREOSCOPIC DISPLAY AND METHOD FOR DISPLAYING THREE-DIMENSIONAL IMAGES

(76) Inventors: Dmitry V. Bakin, San Jose, CA (US); Sergey Babin, Castro Valley, CA (US)

Correspondence Address: Dmitry Bakin, 7119 Via Romera, San Jose, CA, 95139, US

(21) Appl. No.: 11/307,655

(22) Filed: Feb. 16, 2006

Related U.S. Application Data
(60) Provisional application No. 60/593,826, filed on Feb. 17, 2005.

(51) Int. Cl. G09G 5/00

(52) U.S. Cl. 345/613

(57) ABSTRACT

A display device (10) having pixels elements (118) divided into subpixel zones (131), so that each subpixel zone is associated to a predetermined viewing direction (160, 162, and 164). The light outputs of subpixel zones are controlled by an array of scanning focused electron beams (82). Each electron beam corresponds to a different pixel. The subpixel zones of the pixel are activated by electron beam in accordance with the input data signal (280). An array of microlenses (120) is provided in front of the pixels, so that each column of microlenses corresponds to a different column of pixels. The microlens projects the light outputs of the subpixel zones of the corresponding pixel into observation directions (170, 204) creating direction-dependent view of the pixel. The thin-panel display device is capable generating high-resolution real-like 3D images of scenes, objects, and models. Observers do not require wearing any special devices or glasses.

### DESCRIPTION

This application claims the benefit of our Provisional Patent Application Ser. No. US60/593,826 filed Feb. 02, 2005.

### FEDERALLY SPONSORED RESEARCH

Not Applicable

### SEQUENCE LISTING OR PROGRAM

Not Applicable

### FIELD OF THE INVENTION

This invention relates generally to information image displays and more particularly to thin-panel multi-view autostereoscopic displays.

### BACKGROUND OF THE INVENTION

In normal human perception the visual impression of depth is determined by the difference in the horizontal viewing angle of a scene seen by both eyes. This is called visual parallax. Moreover, if a human requires additional depth information on an image, he or she will intuitively first try to gain this by a horizontal displacement (i.e. moving the head or the whole body from side to side), to perceive spatial information of the scene through motion parallax.

Many prior art techniques for creating stereo images (such as stereo viewers, polarizing glasses, and switching shutter glasses) are based on creating a different image for each eye. These stereo imaging techniques do not fully reproduce three-dimensional visual perception of the scene because an observer sees the same two images from every angular position. The difference between convergence distance of the eyes (perceived position of the object) and focusing distance (actual position of the display) put tension on the observer and cause fatigue, limiting practical use of stereo display systems. Various methods and devices have been suggested for displaying a true three-dimensional (3D) image. The underlying principle of all true 3D methods is the same. A two-dimensional image displayed on a surface is perceived as plane when every point of the surface produces the same visual impression in all directions. This is the working principle of a traditional picture, like a postcard or a traditional TV image. In the case when a three-dimensional image is presented, the light emitted from the same point has different visual information in different directions. We may regard in this way a window pane or a hologram as a display. Hence, in order to display a three-dimensional image on a flat surface, the visual information from a single image point of a display (pixel) need to be controlled as a function of the observation angle. In other words, the intensity of the light emitted in different directions may be controlled. This approach allows generating multi-view 3D autostereoscopic images, in which the scene volume information is encoded into the image observed from multiple independent positions.

In order to produce true or realistic high-resolution three-dimensional images, several technical problems must be solved. Firstly, a large number of light beams must be projected in the different directions in space, with the appropriate intensity/color, which allow the viewer to see different perspectives from different viewpoints. Secondly, means must be provided to allow the feeding of the necessary data to the light sources generating the light beams. This second problem involves difficulties when video images (i.e. moving images) must be displayed, because large amounts of data must be forwarded into each image point or pixel. Obviously, a real-like true 3D video image providing multiple different viewing directions requires generating the data amount several times greater than required to generate a normal video image.

The preferable methods of separating visual information into multiple viewing directions employ a parallax barrier and an array of microlenses, particularly lenticular lens array, installed in front of the display. In a multi-view lenticular system each view of a pixel is projected from a relatively narrow strip. The width of the strip is dependent on the spot size of the display. Each strip becomes in a sense individually addressable subpixel of a pixel of an image. In order to create high-resolution 3D image, the number of individually addressable subpixels increases proportionally to the number of viewing angular positions. The relevant references are provided with Information Disclosure Statement and are incorporate here in their entirety.

Various types of displays may be used for displaying 3D video images. Liquid crystal display (LCD) panels have a relatively large strip width and relatively low pixel modulation speed. As a result LCD panels may be impractical to use for displaying high-resolution autostereoscopic images. LED or OLED panels could potentially be attractive solution, but at current state of development they are either very costly or not available in large sizes. They are also characterized by high power consumption and low reliability. Relatively small spot sizes can be achieved in conventional CRTs. Some ingenious solutions were suggested including addition of slit mask array in front of phosphor plate for subpixel signal modulation with depth information. However, to achieve small spot sizes and high resolution in a CRT, relatively high voltages, fast video amplifiers, and short-decay phosphors are required, leading to added circuit complexity, power consumption, and manufacturing cost. Furthermore, for optimum results, the lenticular screen is preferably located close to a flat image source. Because of that the lenticular screen may be unsuitable for many conventional CRTs with thick cover glass. As an alternative solution a modified flat Vacuum Fluorescent Display (VFD) having a plane cathode, a focusing magnetic plate with through channels, and a corresponding array of deflecting electrodes have been suggested. From the description of this device it appears that while potentially being able to overcome some of the CRTs limitation, this display will still have low efficiency and relatively large light emitting spot sizes. As another alternative development, some practical high-resolution autostereoscopic displays were built based on rear-projection systems. These systems are bulky, expensive, and typically have reduced screen brightness.

Among the two-dimensional thin-panel display technologies, along with plasma, OLED, electrophoretic, VFD, and LCD concepts, field emission type displays (FED) and particularly their recent variation—surface conducting emission displays (SED) provide high quality of images and good reliability.

### OBJECTS AND ADVANTAGES

It is desirable to provide a thin-panel autostereoscopic display in which the aforementioned problems associated with conventional stereoscopic display technologies, such as LCD, LED, VFD, and CRT, are solved. What needed in the art are a high-resolution device and a method for generating and reconstructing multi-view three-dimensional high-resolution images. The observers should be able to see the real-like volumetric images of the scene without wearing any special devices or glasses. The images should be preferably transmitted using conventional video signals.

Accordingly, it is an object of the present invention to provide a method and a display device which solves the problem of generating light beams from pixels of the display controllable in multiple directions and the problem of passing on the data to the pixels. It is further an object to provide a thin-panel display that has high resolution, improved brightness, fast response, and low power consumption.

### SUMMARY OF INVENTION

The present invention provides a display device for displaying a 3D autostereoscopic high-resolution image of a scene or a model from an input image data, the image data including three-dimensional information. The display device comprises a plurality of pixel elements generating controllable light outputs. The pixels are divided into subpixel zones, so that each subpixel zone is associated to a predetermined viewing direction of the image. According to the invention, the display device further comprises an array of electron sources to generate electron beams and an array of deflectors to scan the electron beams. Each electron beam corresponds to a different pixel. The electron beams impinge upon a subpixel zones of the corresponding pixels. The beams are scanned across the subpixel zones of the pixels within a frame period of the display, addressing one or more zones at a time. Each electron beam is controlled during the scan delivering separate electron flow to each subpixel zone. The subpixel zones are activated in accordance to the input data signal. Multiple pixels may be activated in parallel, each by the corresponding electron beam. An array of microlenses is provided in front of the pixels, so that each column of microlenses corresponds to a different column of pixels. Each microlens projects the output of the corresponding pixel into the viewing angle of the display device so that the different subpixel zones correspond preferably to the different viewing directions. The light outputs from neighboring zones may overlap, creating continuous view of the pixel within the full extension of observation angles. The thin-panel 3D display device in accordance with the present invention is capable of generating large high-resolution autostereoscopic images observable from multiple directions. The observers are not required to wear any special devices or glasses. It is foreseen that adding two dimensional scan of the electron beam within a pixel delivers variable content, which allows seeing 3D in vertical direction in addition to horizontal.

The invention also includes electron beam addressing and controlling means. It is foreseen that an input data processing unit processes 3D component of the image signal corresponding to multiple viewing positions, and modifies signal allocated to each pixel, so that electron beam impinging on that pixel is controlled in sync with input to deflecting electrodes. The image control system may take advantage of the high level of data redundancy present in the multi-directional autostereoscopic display image. The image signal generator may be furnished with memory buffers and shift registers for parallel feeding the 3D data into multiple pixels. The image signal processor may further comprise a decoder for decoding stream of input compressed 3D video data.

In terms of 3D images, the advantage of flat-panel electron emission type displays over any purely optical light-valve displays like LCD is a much greater level of flexibility of an electron beam. Electrons can be easily deflected, turned on and off, focused, and varied by their number. This gives an opportunity to create a true 3D effect by controlling electrons before they hit pixel elements. Specifically electron beams may be focused into extremely small (sub-micron) spot, and scanned and switched on and off extremely fast (nsec). The 3D content of the display in according to the presented invention is created on the level of a single pixel. This brings a major advantage—it allows keeping resolution of the display at a high level with no degradation when switching from 2D to 3D. At the same time electron beam array may provide jitter-free image with high brightness and high contrast on the screen. These advantages allow creating high-resolution display capable to operate at video rate, and to provide autostereoscopic effect simultaneously for multiple observers situated at multiple viewing positions. High-density directional images allow avoiding disassociation between accommodation function and vergence function of the eyes.

### DRAWINGS

### Brief Description of the Drawings

Preferred embodiments of the present invention will now be described by way of examples only with reference to the accompanying drawings in which:

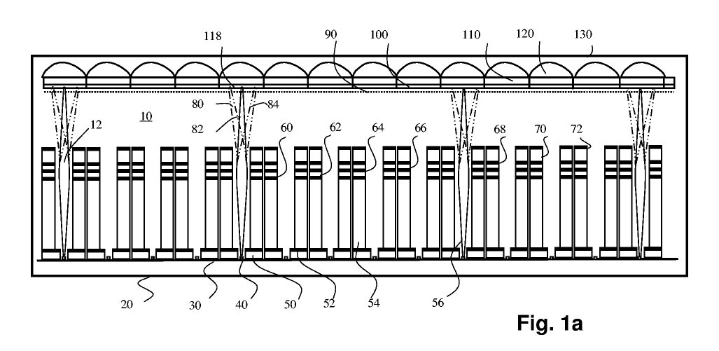

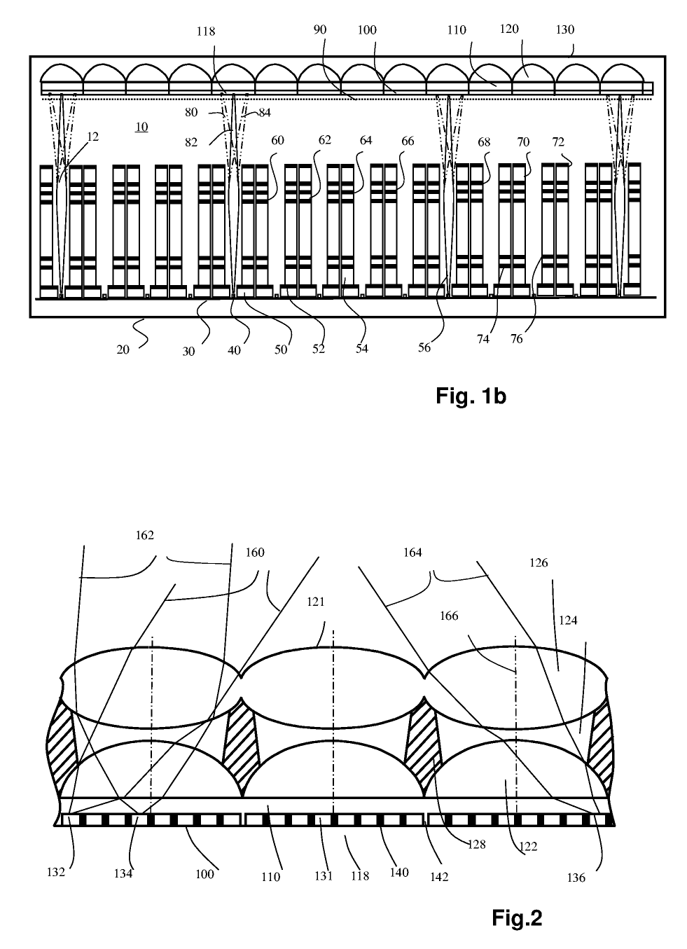

FIG. 1a is a cross-sectional view of a high-resolution electron beam array display device displaying autostereoscopic images;

FIG. 1b is a cross-sectional view of the modified device shown on FIG. 1a with an additional layer of electron beam focusing electrodes;

FIG. 2 is a cross-sectional view of a segment of a compound lenticular stereoscopic display;

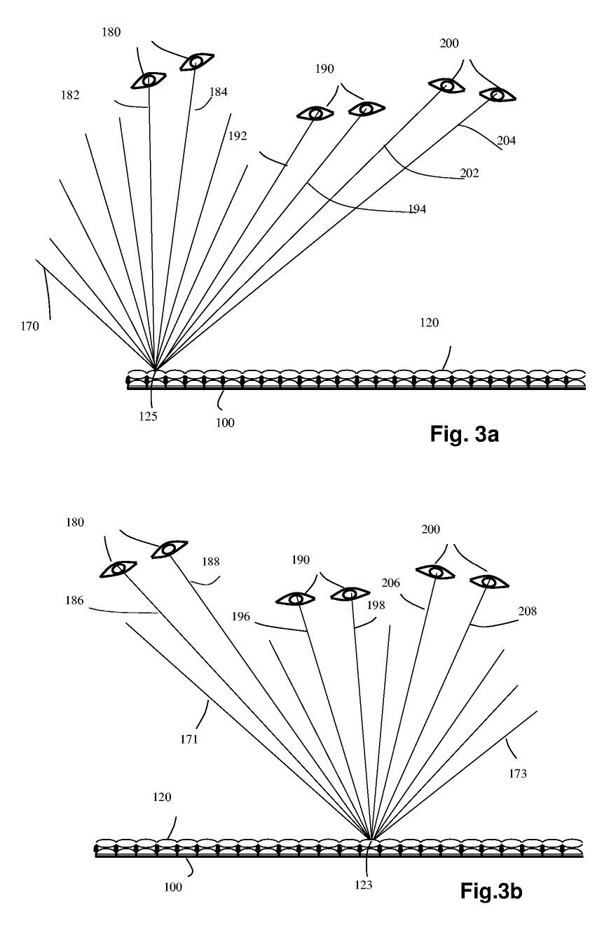

FIG. 3a is a side view of a lenticular stereoscopic display illustrating 3D image parallax formation;

FIG. 3b is another view of display shown on FIG. 3a further illustrating image parallax formation;

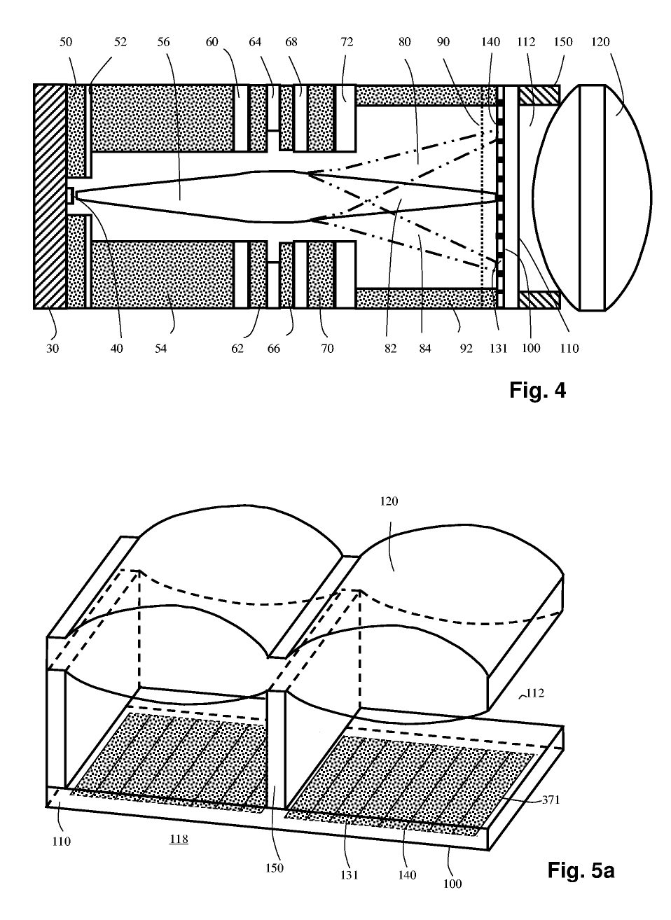

FIG. 4 is a cross-sectional view of an example of a pixel element of the display device with a scanning electron beam cell;

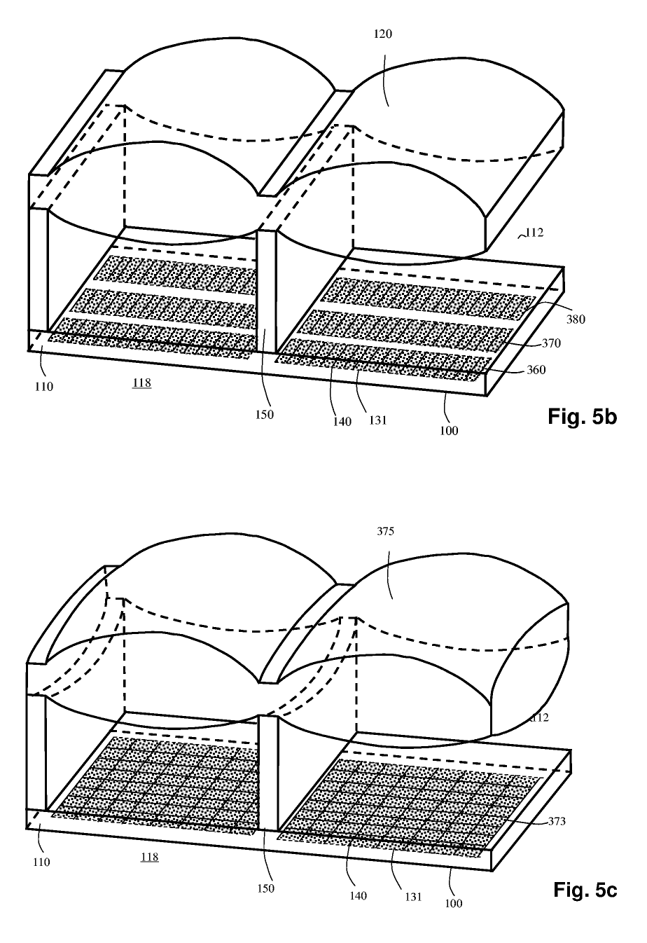

FIG. 5a is a perspective view of a segment of the display device with a single color phosphor pixel;

FIG. 5b is a perspective view of a segment of the modified display device with red, green, and blue color phosphor strips combined in one pixel;

FIG. 5c is yet another perspective view of a segment of the modified display device with two-dimensional array of color phosphor segments in one pixel;

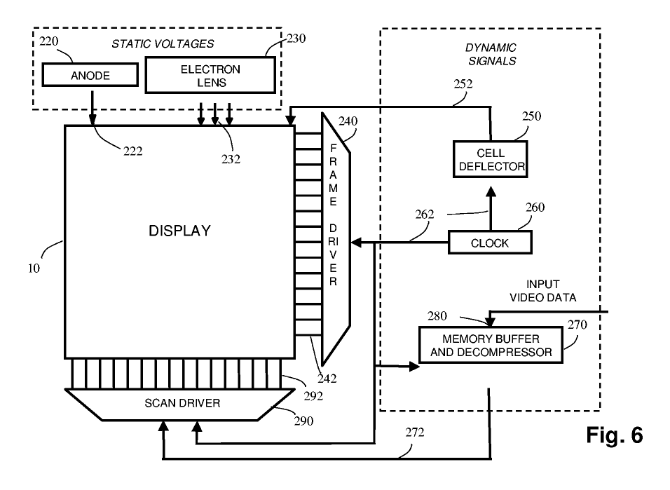

FIG. 6 is an electronic signal circuit block diagram of an autostereoscopic display system embodying the present invention;

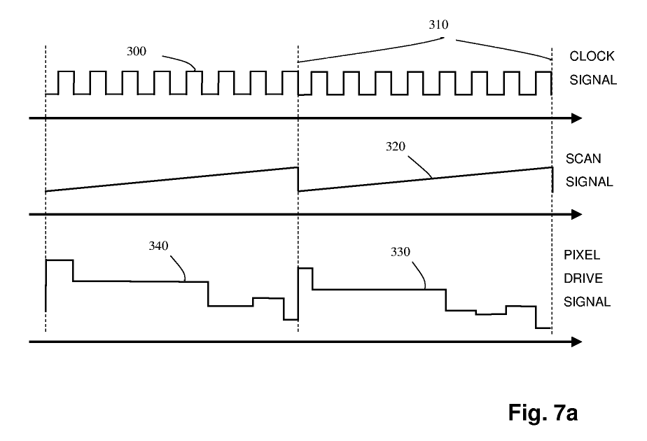

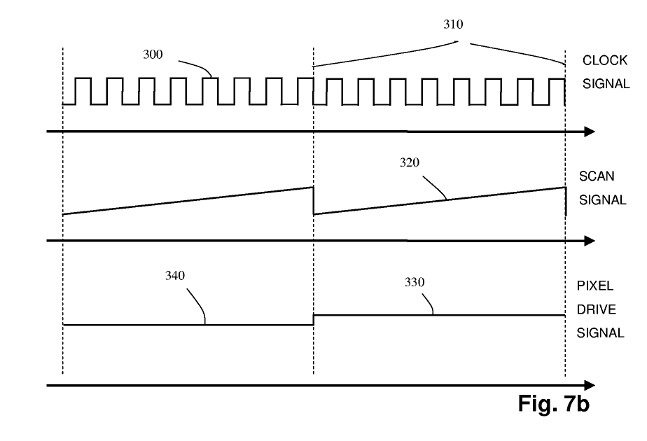

FIG. 7a is an example of a timing diagram for addressing individual pixel driver signal of an autostereoscopic display device; and,

FIG. 7b is another example of a timing diagram for addressing a pixel driver signal, when 3D display device according to the present invention is operating in a 2D mode.

### REFERENCE NUMERALS IN DRAWINGS

10 display

12 electron beam cell

20 vacuumed envelope

30 supporting plate

40 cathode

50 insulating layer 1

52 control electrode

54 insulating layer 2

56 controlled electron beam

60 focusing electrode 1

62 insulating layer 3

64 focusing electrode 2

66 insulating layer 4

68 focusing electrode 3

70 insulating layer 5

72 deflecting electrodes

74 focusing electrode 4

76 focusing electrode 5

80 left deflected electron beam

82 focused electron beam

84 right deflected electron beam

90 final anode layer

92 insulating post

100 light emitting layer

110 supporting glass plate

112 gap 2

118 pixel element

120 microlens element

121 microlens assembly

122 optical element 1

123 right pixel

124 gap

125 left pixel

126 optical element 2

128 optical elements spacer

130 transparent window

131 subpixel strip zone

132 left subpixel zone

134 center subpixel zone

136 right subpixel zone

140 subpixel isolating wall

142 pixel isolating wall

150 mounting post

160 right collimated beam

162 center collimated beam

164 left collimated beam

166 optical axis

170 left beam from pixel 125

171 left beam from pixel 123

173 right beam from pixel 125

180 observer 1 eyes

182 beam to the right eye of observer 1 from pixel 125

184 beam to the left eye of observer 1 from pixel 125

186 beam to the right eye of observer 1 from pixel 123

188 beam to the left eye of observer 1 from pixel 123

190 observer 2 eyes

192 beam to the right eye of observer 2 from pixel 125

194 beam to the left eye of observer 2 from pixel 125

196 beam to the right eye of observer 2 from pixel 123

198 beam to the left eye of observer 2 from pixel 123

200 observer 3 eyes

202 beam to the right eye of observer 3 from pixel 125

204 right beam from pixel 125

206 beam to the right eye of observer 3 from pixel 123

208 beam to the left eye of observer 3 from pixel 123

220 anode circuit

222 anode feed voltage

230 electron lens circuit

232 electron lens feed voltages

240 frame driver circuit

242 frame driver signal

250 cell deflector circuit

252 cell deflection signal

260 clock circuit

262 clock signal

270 memory buffer and decompressor circuit

272 decompressed video signal

280 input video data signal

290 scan driver circuit

292 pixel driver signal

300 detailed clock signal

310 frame cycle marks

320 ramp scan signal

330 detail pixel signal 1

340 detail pixel signal 2

360 red phosphor strip

370 green phosphor strip

371 mono-color subpixel zones

373 two-dimensional subpixel zone

375 convex circular microlens

380 blue phosphor strip

### DETAILED DESCRIPTION OF PREFERRED EMBODIMENTS

The making and use of the various embodiments are discussed below in detail. However, it should be appreciated that the present invention provides many applicable inventive concepts which can be embodied in a wide variety of specific contexts. The specific embodiments discussed are merely illustrative of specific ways to make and use the invention, and do not limit the scope of the invention.

In a particular embodiment a display device comprises a lenticular lens array having, in a preferably horizontal direction, a pitch size corresponding to a pixel size of the display, a phosphor layer disposed behind the micro-lens array, a phosphor layer is divided into a plurality of color pixels. Each pixel may have a plurality of juxtaposed subpixel zones. The display device further comprises an array of field-emission cathodes for generating an electron flow, an array of control electrodes disposed in the vicinity of the cathodes for selectively controlling, in response to the image signal, flow of electrons from a cathode to a corresponding pixel, an array of focusing electrodes disposed above an array of control electrodes for focusing electron beams on the phosphor layer. The display device further comprises an array of deflecting electrodes disposed above focusing electrodes for deflecting electron beam sequentially by small steps across the pixel in synchronization with clock signal. The deflection electrodes provide subpixel addressing and scanning of the corresponding pixel. Within each pixel the electron beam impinging on the subpixel zone activates the cathodoluminescent phosphor, the phosphor emits light. The amount of the emitted light corresponds to the electron beam flow, and is affected by an applied voltage, the charge, or the current provided by the electron beam to that subpixel zone. The light generated by the subpixel zone is collimated by the corresponding lenticular lens and is emitted at an angle predetermined by the lateral shift of that zone relative to the optical axis of the corresponding lens, and by the focal length of the lens. The resulting plurality of light beams radiating from the array of microlenses in multiple directions provide image with three-dimensional visual content for observation from multiple position around the display device.

Providing that angular difference between the light beams emitted from subsequent subpixel zones is smaller then visual parallax of an observer, and pixel size of the display is sufficiently small, a high-resolution image is created with a true 3D-like feeling. The system may use normal two-dimensional display information, which has been compressed to combine multi-view information for each pixel. The final information density (bandwidth) needed to reconstruct the three-dimensional image using this technique depends on the redundancy of the scene, and may be up to several times higher than the information density needed to reconstruct a two-dimensional image. The described system is constructed such that the signal used for three-dimensional display can be used on a two-dimensional display and that the signal used for two-dimensional display can be used on a three-dimensional display, what is called forward and backward compatibility. This technique allows, as such, a continuous evolution in consumer display and television markets from two-dimensional displays to three-dimensional displays.

Referring now to FIG. 1a, an example of a display 10 for displaying three-dimensional images comprises an array of electron beam cells 12, and a light emitting phosphor layer 100 facing the cells 12. The layer 100 comprises an array of pixel elements 118 for forming an image. The layer 100 is deposited on one surface of a supporting glass plate 110, and an array of microlens elements 120 is disposed on the opposite surface of the glass plate 110. The thickness of the glass plate 110 is selected so that the phosphor layer 100 is substantially at a focal plane of the microlens element 120. For the purposes of explanation of the operation of the display, the direction from the plate 110 to microlens 120 is referred to as the direction from the bottom to the top. A final anode layer 90 is disposed on the bottom of layer 100. The display 10 is placed inside a thin-panel protective vacuumed envelope 20 with a transparent window 130 on the top.

The electron beam cell 12 comprises a field emission cathode 40 disposed on a supporting plate 30. Cathodes 40 are arranged into a two-dimensional pattern corresponding to a pixel structure of the display. Electron beam cell 12 further comprises a control electrode 52 disposed above the cathode 40 and sandwiched between an insulating layers 50 and 54. The cathode 40 and control electrode 52 are generating a controlled electron beam 56 for an individual pixel of the image, controllable in accordance to an input video signal. The cell 12 further comprises successive layers of focusing electrodes 60, 64, 68 separated from each other by successive insulating layers 62 and 66 sandwiched between the insulating layers 54 and 70, and a layer of deflecting electrodes 72 disposed on top of layer 70. The insulating layers, the focusing electrodes, and the deflecting electrode form a stack disposed on top of the control electrode 52.

An alternative design of the focusing electrode assembly is shown on FIG. 1b, where two additional layers of focusing electrostatic plates 74 and 76, sandwiched between insulating layers, are added to the electron beam cell 12 on top of the control electrode layer 52. The alternative design allows improving focusing control of the electron beam 56 and improving stability.

In operation the electron beam 56 is accelerated and focused by voltages applied through electrodes 52, 60, 64, 68, 72, 90, and impinging as a focused beam 82 onto a spot on layer 100 within the pixel 118, so that this spot is emitting visible light. The amplitude of the emitted light is controlled by the current of the focused electron beam 82. The deflecting electrodes 72 scan the beam 82 over the surface of the layer 100, forming, at various moments within a video signal frame, electron beams 80 and 84 deflected correspondingly to the left and to the right from the beam 82. The emitted light is collimated and projected by the microlens 120 and is observed by viewers. The microlens 120 limits observation field of view to only one viewing direction per light emitting spot on layer 100 within the pixel 118. Different light emitting spots on layer 100 generated by scanning electron beam 82 produce different light beams viewable at different directions per individual pixel 118, thus enabling display image with controllable direction-dependent views of the pixels. In the alternative implementation of the display device the individual electron beam element 12 corresponds to two or more pixels 118.

Depending on the display size and required native image resolution, the size of the pixel 118 may vary between 0.02 mm and 10 mm. We anticipate the display device according to the current invention being utilized in a variety of applications ranging from mobile phones, miniature information windows, special application displays, and computer monitors to large screen TV screens, stadium units and advertisement billboards. Corresponding displays sizes may vary between 20 mm and 20 m.

Referring now to FIG. 2, a cross-sectional view of a segment of a compound lenticular stereoscopic display is shown. The microlens assembly 121 is modified from microlens 120 on FIG. 1 to comprise cylindrical optical elements 122 and 126, aligned along the optical axis 166. The element 126 is positioned on top of the element 122. The elements 126 and 122 have a gap 124 between them and are separated by spacers 128. Spacer 128 is also an optical stop. It restricts an aperture of the microlens assembly, blocks side light rays from entering into adjusting microlens assemblies, prevents pixel-to-pixel optical cross-talk, and improves image quality. The optical element 122 has the plane bottom surface and convex aspherical top surface, the optical element 126 has two aspherical convex surfaces. The microlens assembly 121 has better optical resolution, increased viewing angle and reduced aberrations as compared to a single plano-concave element of microlens 120. In the display assembly the element 122 is disposed on top of the supporting glass plate 110. The focal plane of the microlens assembly 121 coincides with the light emitting layer 100 disposed on the bottom of the layer 110. The layer 110 comprises pixels 118 for generating display images. The pixel 118 now comprises subpixel strip zones 131 juxtaposed by their short sides across the pixel 118 and separated from each other by isolating walls 140. The pixels 118 are separated from each other by isolating walls 142. The isolating walls 140 reduce cross-talk between adjacent subpixel zones 131. Each subpixel zone 131 can be individually addressed by the scanning focused electron beam 82 as referred to in FIG 1.

Only eight subpixel zones 131 per pixel 118 are shown for simplicity. The display system with 8 subpixel zones per pixel will generate 8 images viewable by observers from 8 different directions. It is anticipated that high-resolution display device according to the preferred embodiment of the current invention may have anywhere from two up to several thousand subpixel zones per pixel as may be required by a particular application of the display. The display pixel resolution may vary from 80 vertical lines and 80 horizontal lines up to 10000 lines in any of the directions depending on the display size and application.

Now we address the details of output light formation within a single pixel. As indicated on FIG. 2 the light emitted by zone 132 located at the extreme left part of a pixel is collimated by the microlens assembly 121 into a beam 160 directed at the most right angle from the optical axis 166. Light emitted by zone 134 located close to the optical axis 166 of the lens assembly 121 is collimated into a beam 162 directed close to the optical axis 166, and light emitted by subpixel zone 136 at the most right part of another pixel element 118 is collimated into the beam 164 propagating at the most left angle from the optical axis. Cross-sectional dimensions of the beams 160, 162, and 164 are limited by the open aperture of the microlens assembly 121 and spacers 128. Besides maintaining stable separation distance between optical elements 122 and 126 the spacers 128 also limit optical aperture of the lens assembly 121, and reduce leakage of light between neighboring pixels, which improves contrast and resolution of the image. The pitch of the microlens assembly is preferably fixed and equal to the display pixel pitch; although in some embodiments it may be desirable to have an array having a different pitch in some portions of the array for, e.g. improved viewing angle, to compensate for variations in the screen, and the like.

The microlens assembly 121 should preferably satisfy several requirements:

It should be able to resolve individual subpixel zones to differentiate visual signal emitted in different directions.

It should have low aberrations within the central field of view specified for 3D effect, to reduce color shift and image distortions during 3D effect observations.

It should have acceptable field of view (preferably ±45o or more) in high-resolution mode for creating full 3D effect, and preferably ±90o in low resolution mode for standard 2D image reproduction.

It should have good mechanical and thermal stability, and be compatible with high vacuum environment inside the display protective envelope.

The pitch of the microlens array is equal to the pixel pitch of the display. The vertical and horizontal extensions of the pixel are determined by the display dimensions in horizontal and vertical directions and corresponding number of pixels. For example an XGA display according to preferred embodiment of the current invention with native image resolution of 1024 by 768, and with horizontal and vertical dimensions of the image area equal to 500 mm by 375 mm, has the pixel size of 0.488 mm by 0.488 mm. Correspondingly the pitch of the cylindrical microlens array is S=0.488 mm. Part of the pixel area is blocked by separation walls and posts leaving smaller active surface with horizontal dimension p=0.44 mm. Microlens aperture is vignetted by the supporting posts 128, which provide mechanical stability and blocks unwanted light rays. The high-performance microlens with aperture a=0.20 mm, with half field of view β=45o has the focal distance F=p/2tan(β)=0.22 mm and f#=1.2.

FIG. 3a and FIG. 3b show how the display device according to the preferred embodiment of the current invention is forming high-resolution multi-view 3D images for observation. For illustrative purposes three pairs of eyes indicated by numbers 180, 190, and 200 are shown corresponding to three different observation positions in front of the display. The microlens array 120 is aligned with an array of pixels on the light emitting layer 100. FIG. 3a shows light beams emitted by a microlens aligned with pixel 125 on the left side of the display. Multiple beams are emitted by the microlens covering angular field from −45o to +45o. Slight divergence may be introduced into the beams by offsetting light emitting layer 100 from the focal plane of the microlens array 120. The offsetting allows changing the 3D image information received by observer, and, among other things, to smooth out the distribution of light emitted by the microlens, to avoid interruption in the picture when the observer is moving in front of the display. Beam 170 is deviated to the most left direction from normal to the display when looking in the direction from the display to the observer. Beam 204 is deviated to the most right position within the field of view of the display. The left eye of the observer 180 receives beam 184, the right eye receives beam 182. The left and the right eyes of the observer 190 receives correspondingly beams 194 and 192, while the left and the right eyes of the observer 200 receives correspondingly beams 204 and 202.

The display operates in accordance with the principals of autostereoscopic integral photography, where each pixel of the image generates different light signal for each position of observation, so as if the displayed scene and objects are observed from multiple directions. The device creates high-resolution spatially variable images of scenes, objects, and models. The real-like images are observed when the size of an individual display pixel is smaller then visual acuity of a human eye, and the spatial information changes at least within the perceived visual parallax angle. When the display is observed by a human, having typical center-to-center eye separation of d=65 mm, from the distance of L=2 m, the pixels of an image has the angular parallax between left and right eyes equal to θ=d/L=0.0325 rad. To provide 3D effect in the image at the observed distance, the collimated light beams emitted from each microlens may require having different visual information when shifted by at least the angle θ. Since the beams are emitted from the subpixel zones of the pixel, the separation s between centers of two adjusting zones should not exceed s=If=0.032 mm. If the required observable distance for 3D effect (cut-off distance) is increased to 4 m, then required zone separation should be reduced to 0.016 mm. When the observer moves beyond the cut-off distance, both eyes begin seeing the visual signal emitted from the same subpixel zone, the observer looses parallax information and perceives an image as a regular 2D. Since the typical visual acuity of a human eye under normal room illumination is varies around δ=0.0005 rad, the observer will for example perceive an image generated on the display with the pixel pitch of S=0.488 mm as a realistic image when the observation distance exceeds L2=S/δ=0.976 m. In the presented example each red, green, and blue color strip of the pixel is subdivided into 30 subpixel zones independently addressable by the focused scanning electron beam to provide true-like high-resolution image with 3D effect observable up to a distance of 4 m.

Multiple pixels emit light within one video frame of the display device to create images in accordance with input video signal containing 3D information. FIG. 3b illustrates how light beams emitted by a different pixel 123 located on the right part of the display a viewed by observers 180, 190, and 200. Now left eye of the observer 180 receives beam 188, and his right eye receives beam 186; left and right eyes of the observer 190 see correspondingly beams 198 and 196, while left and right eyes of the observer 200 see correspondingly beams 208 and 206. The pixel 123 produces range of beams between the most left beam 171 and the most right beam 173 for observations at the angles from −45o to +45o. As observer shifts the eyes sideways across the screen he or she receives full illusion of moving parallax, since from a new position he or she will see on the same display slightly different image. At the same time the left and the right eye of the observer also see a different image, which creates visual parallax of the scene. Since the light beams are substantially collimated and the light emitting pixels are smaller then visual resolution of a typical human eye, the light beams are perceived as originated from the objects of the scene. The display is perceived as merely a window through which the scene is observed. As the result of these properties, the described display allows eliminating disassociation between image position and eye convergence distance, and reducing tension, disorientation, and fatigue associated with viewing regular stereoscopic images.

Referring to FIG. 4, a magnified cross-sectional view of the single electron beam cell assembly of the preferred embodiment of three dimensional display apparatus is shown. In accordance with the previously established directional terminology, the supporting plate 30 is at the bottom of the cell assembly, and the microlens 120 is at the top. The plate 30 comprises an array of electrical feed lines and thin film transistors to provide current to the cathode 40, and processed pixel video signals to the control electrode 52. The field emission cathode 40 is formed from surface emitters, using carbon nanotubes technology. Various alternative field emitting technologies may be implemented at this step like arrays of microtips, surface-conducting emitters, and polymer embedded conductive nanoparticles. Several emitting zones may be used to form a scanning e-beam. This approach improves reliability of the system and increases electrons flow. The beam 56 is extracted using a relatively low voltage (0-500 V) applied to control electrode 52. This voltage is a dynamic signal, which turns each pixel on and off and modulates beam intensity. The beam 56 further passes through an electrostatic lens assembly indicated by layers 60, 64, and 68 that focuses the beam onto the phosphor layer 100 under higher voltage potential (typically 10 kV) applied to the anode 90 on layer 100. Layer 100 is deposited on a supporting glass plate 110. The resulting high velocity electron beam 82 has sufficient energy to penetrate the anode and reach the underlying phosphors resulting in light output. An additional supporting insulating post 92 is provided between deflecting electrode 72 and phosphor layer 100 improving mechanical stability of the cell assembly.

The screen is subdivided into subpixel zones 131 separated by isolating walls 140. The electron beam's focal spot is significantly smaller than the size of a display's pixel, and comparable with the size of the subpixel zone. The focused beam is scanned across the single pixel by a scanning signal applied to deflecting electrodes 72, so that multiple subpixels can be addressed sequentially by the beam within one pixel, as indicated by positions of alternative beams 80, 82, and 84. The intensity of the beam is modulated according to an image signal and corresponding to a specific beam position within the pixel of the display.

The emitted light is collimated by the microlens 120. A modified version of the microlens 120 is shown as compare to FIG. 1a, b and FIG. 2, comprising single element with two convex surfaces. Double convex surfaces allow increasing optical power of the microlens, improving image quality, and increasing Field of View. The microlens 120 is mounted on posts 150 on top of the plate 110. There is a gap 112 between the plate 110 and the bottom surface of the microlens 120 for improved optical performance.

Referring now to FIG. 5b, a perspective magnified view of a color pixel element 118 comprising red, green, and blue color strips is shown. The microlens 120 is a cylindrical lens with double convex surfaces. The light emitting layer 100 of the pixel element is in focus of the microlens 120. The layer 100 comprises three strips of red 360, green 370, and blue 380 phosphors, deposited on the bottom of supporting glass plate 110. Each of the color phosphor strips comprises subpixel zones 131 juxtaposed along the strip and separated by isolating walls 140. The posts 150 are mounted on top of the plate 110 to support the microlens array, to provide mechanical stability, and to block unwanted rays. The gap 112 is formed between the microlens 120 and the glass plate 110.

In operation, light emitted from each subpixel zone is collimated by the microlens in one dimension and diverges in the other dimension. The collimated light propagates at an angle to the optical axis defined by an offset of a subpixel from the optical axis of the lens. Each of the subpixel zones of each color strip is addressed sequentially by a scanning focused electron beam within a period of a frame of a video signal. To achieve that function the electron beam is deflected in two directions: one—along the color strip; the other—across the color strips.

FIG. 5a shows a magnified view of a mono-color pixel element. The light emitting surface 100 is covered by a phosphor of one color or a white light emitting phosphor. The surface is divided into subpixel zones 371 isolated by walls 140. The microlens 120—is a double convex cylindrical microlens. The principle of operation of a mono-color pixel cell is similar to the three color cell, except the electron beam is now focused and scanned only in one direction. The advantage of this approach is a simplified electron beam cell design and signal processing; the disadvantage—the cell size is smaller and increased number of cells is required to form 3D color image.

A modified design of a multi-color pixel element is shown on FIG. 5c. Here the light emitting layer 100 is divided into two-dimensional array of subpixel zones 373, comprising red, green, and blue phosphors. The layer 100 is in focus of a microlens 375. The microlens 375 is now a positive double convex circular optical element. The strips of red, green, and blue phosphors are extended along one pixel direction and juxtaposed sequentially in the orthogonal direction. This arrangement of the subpixel zones and the microlens allows creating an image parallax in two orthogonal directions. An observer can now see multi-view autostereoscopic image independent of his or her orientation, and perceive it as a real-like three-dimensional object.

FIG. 6 shows a display 10 connected to electronic control circuits and feed lines. Anode requires high feed voltage 222 (up to 10 KV) generated by Anode circuit 220; Electron Beam Focusing Lens circuit 230 generates smaller voltages 232 (0 V-500 V) needed for electrodes of electron lens. However, these voltages are static, and therefore they require simple electronic control circuits. Dynamic signals circuits comprise Clock circuit 260, producing clock signal 262, Memory Buffer and Decompressor circuit 270 producing decompressed video signal 272, and a subpixel Cell Deflector circuit 250 generating electron beam cell deflection signal 252. The subpixel deflection signal 252 is a repeatable signal synchronized by the input clock signal 262.

The Input Video Data signal 280 comprising scene depth information, is first processed in the Memory Buffer and Decompressor 270, generating a decompressed video signal 272. The signal 272 comes to a Scan Driver circuit 290, which extracts pixel driver signal 292 comprising electron beam modulation information, and feeds it to the display 10 in synchronization with Frame driver signal 242. The synchronization is provided by the Clock signal 262 fed in parallel to the Frame Driver 240 and the Scan Driver 290. Due to high redundancy of the 3D video data, the bandwidth for the compressed video signal transmitted to this 3D display may be only several times higher then the standard HDTV signals.

In operation pixel driver signals 292 are applied to row conductors via row drive circuitry. Column drive circuitry sequentially enables successive columns of pixels. For each column of pixels enabled, row drive circuitry simultaneously applies video data to each of row conductors. The next column of pixels is then enabled by column drive circuitry. Row drive circuitry now applies the video data corresponding to the next column of pixels to row conductors. This scan process continues until the last column of pixels is reached. Clock signal 262 synchronizes row drive circuitry and column drive circuitry to input decompressed video signal 272. The entire process is then repeated for the next frame of input video data 280. In the proposed display device the high voltages are typically static, while dynamic voltages are typically of low voltage.

Referring now to FIG. 7a, the timing for addressing an individual pixel driver signal and a scan signal is synchronized by an input clock signal 300. At the beginning of each color frame 310 the scan voltage 320, applied to the deflecting electrodes of the electron beam cell, is reset to low starting value. The scan signal gradually ramps up towards the high value at the end of the frame cycle, increasing electron beam deflection. Electron beam scans over subpixel zones. At the same time the pixel driver signal 330 is varying at a high data rate giving electron beam intensity modulation in accordance to the subpixel zone position inside the pixel. Each subpixel zone within the pixel generates independently controlled light output in accordance with the pixel driver signal 330. The pixel driver signal 330 comprises 3D video information of the scene. The light output from each of the subpixel zones within the pixel is observed at the corresponding to this zone angle, so that for an observer the same pixel generates different signals at different observation angles.

In dynamic scenes the image is changing between subsequent frames. This is indicated on FIG. 7a by showing pixel driver signal 340 for the frame immediately preceding the frame 310. There are some changes in the signal 340 in comparison to signal 330 caused by the shifting objects in the 3D scene. As it was indicated earlier the display system according to the current invention is compatible with regular two-dimensional video signal.

FIG. 7b shows individual pixel timing diagram for two-dimensional video signal. Here pixel driver signal 330 does not change during the whole frame, so that each of the subpixel zones within the pixel generates the same light output. Correspondingly, the pixel produces the same image information for all observation angles, as in regular two-dimensional image display. The image information may change between the frames, as indicated by the difference between signals 330 and 340, but, in case of a 2D image video signal, it causes uniform changing in the pixel driver signal amplitude for the duration of the frame.

While there have been illustrated and described what are at present considered to be preferred embodiments of the present invention, it will be understood by those skilled in the art that various changes and modifications may be made, and equivalents may be substituted for elements thereof without departing from the true scope of the present invention. For instance, the term lenticular array may be interpreted to include various arrangements of lens structures such as rotated cylindrical lenses or rotated microlenses. This applies equally to arrays 120 and 121. In addition, various exemplary embodiments of the present invention may be applied to a variety of types of displays, including flat panel displays such as field emission displays, surface-conducting emission displays, electrophoretic displays, vacuum fluorescent displays, and plasma emission displays. Various modifications of display forms, electrode shapes and structures, including addition of electrodes or even layers of electrodes, can be foreseen by those skilled in art to achieve similar electron beams focusing and scanning capabilities to address particular pixels of the display. The display devices may also be of curved or even cylindrical or spherical shape to address the needs of panoramic or surrounding three-dimensional observation of scenes, objects, and models.

In view of the foregoing disclosure, one of ordinary skill would readily appreciate that any data structure capable of achieving the display described herein could be used to drive this display device. In addition, different color pixel schemes like for example complementary color sets of cyan, yellow, magenta can be implemented to display color images. Many modifications may be made to adapt a particular situation or material to the teaching of the present invention without departing from the central scope thereof. Therefore, it is intended that the present invention not be limited to the particular embodiment disclosed as the best mode contemplated for carrying out the present invention, but that the present invention includes all embodiments falling within the scope of the appended claims.

The foregoing description and the drawings are regarded as including a variety of individually inventive concepts, some of which may remain partially or wholly outside the scope of some or all of the following claims. The fact that the applicant has chosen at the time of filing of the present application to restrict the claimed scope of protection in accordance with the following claims is not to be taken as a disclaimer of alternative inventive concepts that are included in the contents of the application and could be defined by claims differing in scope from the following claims, which different claims may be adopted subsequently during prosecution, for example, for the purposes of a continuation or divisional application.

What is claimed is:

1. A display device for displaying autostereoscopic images, the display device comprising:
an array of pixels for displaying the images, wherein at least some of the pixels are divided into zones;
an array of electron beam sources, each of the sources corresponding to the different pixel, said sources generating controllable electron beams, said electron beams impinging upon the corresponding pixels;
an array of electron beam deflecting means, disposed between said electron beam sources and said pixels, the deflecting means scanning said electron beams across the zones of said pixels, said zones generating light outputs;
and, an array of microlenses disposed in front of said pixels, the microlenses projecting said light outputs from said zones, forming direction-dependent views of said pixels;
whereby said display device provides the autostereoscopic images for viewing.

2. The display device according to claim 1, wherein said electron beam sources further comprising electron emission cathodes, said cathodes generating flows of electrons.

3. The display device according to claim 2 wherein said subpixel zones are separated by spacers, said spacers reducing cross-talk between the adjacent zones.

4. The display device according to claim 3 wherein said electron beam sources further comprising an array of control electrodes disposed between said electron emission cathodes and said electron beam deflecting means, said control electrodes controlling the flow of said electron beams.

5. The display device according to claim 4, further comprising an array of electron beam focusing electrodes disposed between said array of control electrodes and said array of electron beam deflecting means for focusing said electron beams within said zones of said pixels.

6. The display device according to claim 5 wherein said pixels including a red, a green, and a blue color pixels.

7. The display device according to claim 6 wherein each of said color pixels having a long side and a short side, said color pixels juxtaposed by the long sides, said zones juxtaposed along the long side of said color pixel.

8. The display device according to claim 7 wherein said electron emission cathodes are field emission type cathodes.

9. The display device according to claim 8, further comprising insulating material layers sandwiched between said cathodes, said control electrodes, said focusing electrodes, and said electron beam deflecting means, for providing an electrical insulation, said insulating material layers including a plurality of openings for providing propagation of said electron beams.

10. The display device according to claim 9 wherein said array of microlens is a lenticular microlens array.

11. The display device according to claim 9 wherein said array of microlens is an array of convex circular microlenses.

12. The display device according to claim 10 wherein said lenticular microlens array comprises two or more cylindrical microlens arrays.

13. The display device according to claim 9, further comprising an electron beams control circuits, said control circuits comprising a clock circuit for generating clock signals, a memory buffer and decompressor circuit for producing decompressed image signals out of an input image data, and a deflector circuit for generating electron beams deflection signals, wherein said image signal and said deflection signals are synchronized by said clock signals.

14. A method of generating a three-dimensional autostereoscopic image on a two-dimensional display from an image signal, the image viewable from multiple directions, comprising:
generating an array of controllable electron beams each corresponding to a pixel element of the display;
focusing said electron beams onto zones within the said pixel elements;
scanning said focused electron beams across said zones of said pixel elements;
generating light outputs from said zones, the light outputs controllable according to said image signal;
projecting said controllable light outputs by an array of microlenses, forming direction-dependent views of said pixel elements
whereby said display generating the three-dimensional autostereoscopic image for viewing.

15. The method of claim 14 wherein said array of microlens is a lenticular lens array, and said controllable lights are substantially collimated in at least one direction.

16. The method of claim 14 wherein said pixel element comprising at least one set of red, green, and blue color pixels.

17. The method of claim 14 wherein said image signal is a decompressed image signal comprising visual information for multiple viewing directions for each pixel of the image.

18. A flat panel display for generating autostereoscopic images from an input image signal, the autostereoscopic images having resolution of at least 80 vertical lines and at least 80 horizontal lines, the images viewable from at least 2 different horizontal directions, the display comprising:
an array of pixels for generating said images, the pixels including phosphor layer with a plurality of light emitting zones;
an array of electron emitting cathodes disposed behind said array of pixels, each of the cathodes corresponding to the different pixel, the cathodes generating electron beams;
an array of control electrodes disposed in the vicinity of said cathodes, for controlling said electron beams in accordance to the image signal;
an anode electrode disposed in the vicinity of said phosphor layer for providing an acceleration potential to said electron beams;
an array of electron beam focusing means disposed along the path of said electron beams for focusing each of said electron beams within the subpixel zone of the corresponding pixel;
an array of electron beam deflecting means disposed along the path of said electron beams for directing each of said focused electron beams to the selected subpixel zones within said pixel, said zones emitting controllable light outputs;
and an array of microlenses disposed in front on said phosphor layer, each column of microlenses corresponding to a different column of pixels, the microlenses collimating said controllable light outputs into directional light beams in at least one plane of observation, the different collimated light beams corresponding to said different subpixel zones of said pixel,
whereby said display producing the autostereoscopic image.
